(19) United States
(12) Patent Application Publication
(10) Pub. No.: US 2026/0153654 A1
(43) Pub. Date: Jun. 4, 2026

(54) DEVICE WITH INTERFERENCE LIGHT SUPPRESSION

(71) Applicant: AUMOVIO Germany GmbH, Frankfurt am Main (DE)

(72) Inventor: Thomas Brohm, Münster (DE)

(73) Assignee: AUMOVIO Germany GmbH, Frankfurt am Main (DE)

(21) Appl. No.: 19/386,644

(22) Filed: Nov. 12, 2025

(30) Foreign Application Priority Data
Dec. 3, 2024 (DE) 102024211542.8
Jun. 26, 2025 (DE) 102025124805.2

(51) Int. Cl. G02B 5/00; G02B 27/01

(52) U.S. Cl. CPC G02B 5/003; G02B 27/0101

(57) ABSTRACT

The invention relates to a device having an optical unit (3) which has at least one inner wall (35) provided with a surface structure (351). The surface structure (351) has cavities (352). Such a device is advantageously used in a head-up display with interference light suppression.

### CROSS REFERENCE TO RELATED APPLICATIONS

This application claims priority to German Application Nos. DE10 2024 211 542.8, filed Dec. 3, 2024, and DE10 2025 124 805.2, filed Jun. 26, 2025, the contents of such applications being incorporated by reference herein.

### FIELD OF THE INVENTION

The present invention relates to devices with interference light suppression, in particular head-up displays for generating a virtual image on the windshield of a motor vehicle. A head-up display, also known as HUD, is understood to be a display system which allows the observer to maintain their orientation of view in the direction of travel because the contents to be presented are displayed in their field of view. While such systems were originally used primarily in the aviation sector due to their complexity and cost, they are now also installed in the automotive sector on a large scale.

### BACKGROUND OF THE INVENTION

Head-up displays generally consist of an imaging unit or PGU (picture generating unit), an optical unit and a mirror unit. The imaging unit generates the image and utilizes at least one display element for this purpose. Today's head-up displays typically use matrix displays or scanning image generators to generate images. Displays may be, for example, LC displays (LC: liquid crystal), μ-LED displays (LED: light-emitting diode), LCoS displays (LCoS: liquid crystal on silicon) or DMD systems (DMD: digital micromirror device). One example of a scanning system is a laser scanning system. The optical unit directs the image to the mirror unit. The mirror unit is a partially specular, translucent pane. The observer therefore sees the contents presented by the imaging unit as a virtual image and at the same time the real world behind the pane. In the automotive sector, the windshield also serves as a mirror unit, the curved shape of which is taken into account during presentation, for example by pre-distorting the image presented by the imaging unit. Due to the interaction of the optical unit and the mirror unit, the virtual image is an enlarged and distorted representation of the image generated by the imaging unit.

The observer can only view the virtual image of a head-up display from the position of the so-called eyebox. An eyebox refers to a range of eye positions within the height and width of which the HUD image can be seen. As long as one eye of the observer is within the eyebox, all elements of the virtual image are visible to that eye. However, if one eye or both eyes are outside the eyebox, the virtual image is only partially or not at all visible to the observer. Thus, the larger the eyebox, the less restricted the observer is in choosing their viewing position, which is influenced, among others, by the seating position.

The optical unit of a head-up display usually comprises multiple mirrors to obtain an optical image at the required virtual distance together with the additional mirror element of the windshield. The light emitted by the imaging unit is reflected by a folding mirror, which may be flat or curved, onto a curved primary mirror, which then reflects it toward the windshield. The curved mirrors currently used are designed as substantially flat plates with a large curvature according to the desired optical function. Such curved mirrors are manufactured, for example, from plastic by injection molding or injection-compression molding, or from glass by gravity bending or press bending.

Light reflections in display systems (interference light) may overlay the light of the display (effective light) and thus interfere with the readability of the display. Interference light reflections are caused by single or multiple deflections of the uncontrolled interference light, e.g., by solar irradiation, which may be particularly bright and disturbing. The deflection may occur both by specular reflection (angle of reflection equals angle of incidence) and by diffuse reflection (angle of reflection independent of angle of incidence).

Known methods of avoiding interference light reflections are:
A) Geometric reflection suppression: by inclining or curving surfaces, reflections are deflected so that they can no longer reach the field of view, or eyebox, of the display's observer.
B) Reflection suppression by matting: here, surfaces are matted using suitable processes, wherein increased absorption in combination with diffuse widening reduces the intensity of the interfering reflection.
C) Reflection suppression by transparent interference layers:
here, the reflection of incident light beams on transparent materials is suppressed by stacking thin layers with the aid of destructive interference.
D) Reflection suppression by transparent micro-optical layers: here, the flat cover glasses on backlit displays are provided with partially transparent micro-optical structures which redistribute the interference light through light refraction.

Known implementations of method A) are, e.g., curved cover glasses of displays such as instrument clusters or head-up displays. However, the so-called venetian blind films also utilize geometric suppression of interference light in relation to effective light.

There is a wide variety of known implementations of method B); all types of absorbing and/or rough surfaces are known in this respect. Surfaces painted black primarily work through absorption, as do the well-known moth-eye structure and other textured surfaces.

Known applications of method C) include display systems, e.g., as an anti-reflective coating on TFT displays, and it is also known from commercially available visual aids or camera lenses and telescopes.

Combinations of methods A) and B) are also applied, such as grooved apertures which are additionally painted or textured. Venetian blind films (privacy films) with a rough, matte surface are also common and utilize A) and B). For transparent surfaces, A) and B) are also occasionally combined with C).

### Problems in the Prior Art

A) Geometric reflection suppression: is only partially effective, especially with diffusely reflecting surfaces, requires an alignment of the surfaces and thus requires additional installation space; further, the spatial arrangement may limit functions of the display (visibility among others).
B) Reflection suppression by matting: is either only partially effective or very complex and therefore expensive.
C) Reflection suppression by interference layers: complex manufacturing and cost increases with the required grade, application is limited to certain material surfaces.
D) Transparent, optical micro-structures on displays must be manufactured with high precision, thus being complex, to avoid disturbing side effects (e.g., moiré).

US 2020/0371352 A1, incorporated herein by reference, relates to reflection reduction in the HUD and mentions a surface structure on surfaces inside the HUD. The prism-shaped ribs and the pyramids mentioned therein (also described with a polygon base in the text) have even surfaces inclined towards each other. This is a disadvantage as they serve as ‘mirrors’ for the specular fraction of the scattered light and thus create glossy surfaces as soon as the surface between the interference light source and the observer is at the correct angle.

US 2011/0051251 A1, incorporated herein by reference, relates to an optical element having an anti-reflection function, and shows structures with spherical or even flat upper surfaces as a surface structure, which is a disadvantage as these serve as ‘mirrors’ for the specular fraction of the scattered light and thus create glossy surfaces as soon as the surface between the interference light source and the observer is at the correct angle.

Limitations of existing solutions include that the real reflection, which is composed of diffuse reflection and specular reflection, causes the geometric reflection reduction, which is designed for the specular fraction, to only have low effectiveness. An additional paint finish dampens all fractions, so basically does not change anything. The geometry is also particularly effective when the incidence of light is flat. Further, the upper edges of the grooves additionally scatter back light, valleys absorb more light, and a disturbing light-dark striped pattern is created. An improvement, in particular an avoidance of the side effect of a “striped pattern in the field of view” is desired.

### SUMMARY OF THE INVENTION

An aspect of the invention is to modify the surface of the inner, opaque components in the mirror optics of a head-up such that the diffuse backscatter of sunlight cannot lead to disturbing bright spots in the driver's field of view. For this purpose, planar housing parts must be created which do not reflect any scattered light and thus appear deep black. Such housing parts may be used not only in displays, but anywhere where interference light needs to be effectively suppressed.

A device according to an aspect of the invention with an optical unit which has at least one inner wall provided with a surface structure is characterized in that the surface structure has cavities. Thus, according to an aspect of the invention, planar structures are proposed which effectively suppress the real scattered light, which is composed of specular and diffuse scattered light. They advantageously have cavities into which the interference light may penetrate.

Advantageously, pegs or webs are arranged between these cavities. The cavities are thus formed by pegs and/or webs. The pegs and/or webs create the upper side of the component opposite the wall, interrupted by the cavities and facing the interference light, which appears almost homogeneous with a high number of cavities per surface.

Advantageously, the pegs and/or webs are arranged on the wall, on the one hand, and do not have any flat surfaces parallel to the wall on their upper side facing away from the wall, on the other hand. This largely reduces the probability that interference light may be specularly reflected towards the observer already at the upper side of the component.

Advantageously, the cavities formed by pegs and/or webs have an upper-side opening parallel to the surface of the wall and a height perpendicular to the surface of the wall, in which the ratio of height to mean opening width has a value of 1:2 or greater. This ensures that the flanks of the pegs and/or webs are inclined by more than an average of 45° relative to the wall or the upper side, for example, a height to opening width of 1:1 results in a mean inclination of the flanks relative to the surface normal of 27°. Such ‘steep’ flanks largely reduce the probability that interference light may be reflected back towards the observer at the flanks in a single specular or diffuse reflection.

Advantageously, the cavities have an irregularly shaped cross-section. This largely prevents interference light, which enters the cavities at an angle through the upper-side openings, from being specularly reflected back and immediately exiting again. Instead, the interference light is preferably scattered laterally away from the direction of incidence at the irregular flanks of the cavity.

Advantageously, the flanks of the cavities and/or the pegs and/or the webs have uneven boundary surfaces. Such uneven boundary surfaces are advantageously able to be produced using a 3D printing process, which automatically leads to uneven boundary surfaces due to the smallest possible dimensions of a 3D printing material volume. The stochastic irregularities at the boundary surfaces further reduce the probability that interference light may again exit the cavities towards the observer after only a few specular and/or diffuse reflections. This refers to stochastic irregularities the structural size of which is a multiple of the light wavelengths spectrally present in the interference light.

Advantageously, the flanks of the cavities and/or the pegs and/or the webs have a broadband light-absorbing surface. The higher the broadband spectral absorption of the interference light, the faster the intensity of the interference light fraction which is repeatedly specularly or diffusely reflected in the cavities decreases.

Advantageous embodiments usable individually or in combination are thus:
A) the cavities have a variable cross-section.
b) The cavities do not have any even boundary surfaces at their flanks.
c) The pegs or webs do not have any flat surfaces parallel to the base area on the upper side.
D) the pegs or webs, as well as the base area, have a broadband light-absorbing surface.
e) The structural height of the cavities in relation to their upper-side, mean opening width is at least 1:2.

It is advantageous to provide pointed cones with a round base as the pegs. The pointed cones with a round base according to an aspect of the invention do not have the problem of surfaces which serve as ‘mirrors’ for the specular fraction of the scattered light and thus create glossy surfaces as soon as the surface between the interference light source and the observer is at the correct angle.

Advantageously, the pegs have the shape of a Halma pawn with a pointed cap. Here, instead of a spherical head, the Halma pawn has a pointed cap. The pointed shape reduces specular reflections. The indentation between the lower part of the pointed cap and the neck of the Halma pawn increases the probability that upward light rays are absorbed at the indentation, thereby improving the interference light suppression. Towards the bottom, the adjacent conical bodies create increasing narrowing of the cavities such that the wall below has only minimal even surfaces between the closely arranged cones, the surface normal of which is directed towards the opening of the cavities at the upper side. These remaining even surfaces between the cones are also advantageously curved to suppress direct back reflections in the event of vertically incident interference light.

The pegs or webs are preferably made of a hard material. This has the advantage that they cannot be easily bent or otherwise deformed, and thus retain their light-swallowing properties even under adverse influences. Suitable materials are, for example, plastics such as polycarbonate (typical: Young's modulus of 2.4 GPa and tensile strength of 65 MPa) or polyamide (typical: Young's modulus of 1.9 GPa and tensile strength of 50 MPa).

Advantageously, the pegs and/or the webs consist of a material which may be applied in an additive process, whereby the additively produced, smallest possible volume elements do not combine to form a smooth surface, but instead create a roughness of the surface. For example, in certain 3D printing processes, polyamide creates a granular fine structure on the surface by accumulating the smallest volume elements.

A head-up display according to an aspect of the invention has a wall in the device structured according to an aspect of the invention. In this way, effective interference light suppression is achieved.

The interference light suppression according to an aspect of the invention significantly outperforms painted and/or textured surfaces in interference light absorption. The gloss level is particularly low and the surfaces implemented according to an aspect of the invention appear deep black. Even with bright sunlight as the interference light, a completely matte (dull) and color-neutrally dark (almost black) appearance can be achieved.

An aspect of the invention also relates to interference light suppression in all types of illuminated devices or even in rooms.

### BRIEF DESCRIPTION OF THE DRAWINGS

Further advantages and embodiments of the invention will become apparent from the following description with reference to figures, in which:

FIG. 1 shows a head-up display for a means of transport;

FIG. 2 shows a view from the interior of a motor vehicle through its windshield;

FIG. 3 shows a sectional view of a wall of an optical unit;

FIG. 4 shows the relationship between real, specular and diffuse reflection;

FIG. 5 shows an enlarged section of a wall with grooving;

FIG. 6 shows multiple surface structures according to an aspect of the invention;

FIG. 7 shows a side view and a cross-section of different example pegs;

FIG. 8 shows an example grid with tubular elements; and

FIGS. 9-15 show further advantageous surface structures.

### DETAILED DESCRIPTION OF EXEMPLARY EMBODIMENTS

For better understanding of the principles of the present invention, embodiments of the invention are explained in more detail below with reference to the figures. The same reference numerals are used in the figures for identical or functionally identical elements and are not necessarily described again for each figure. It is to be understood that aspects of the invention are not restricted to the illustrated embodiments and that the features described may also be combined or modified without departing from the scope of protection of aspects of the invention as defined in the appended claims.

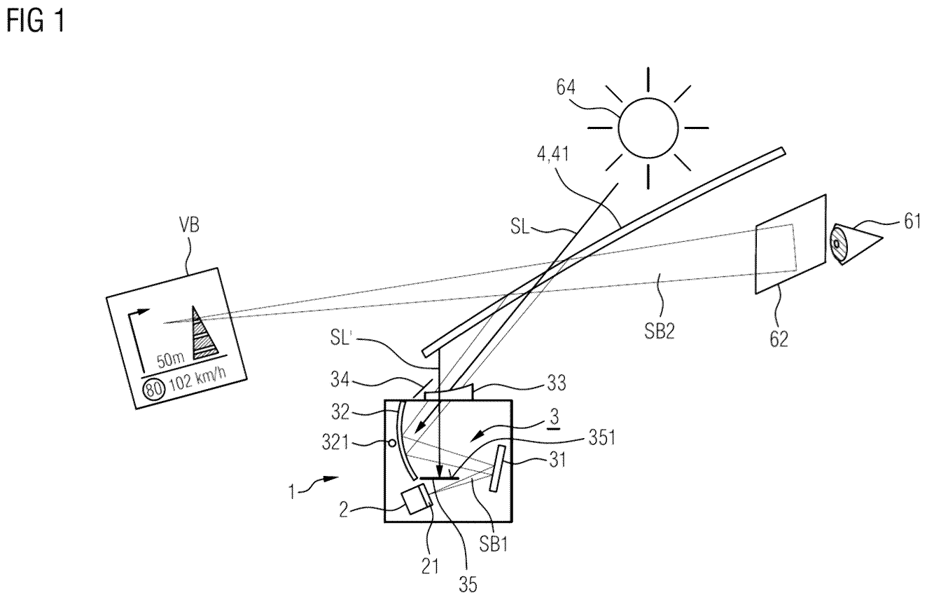

FIG. 1 schematically shows a head-up display for a means of transport as an example of an image generation system 1. The head-up display has an imaging unit 2, an optical unit 3 and a mirror unit 4. A beam of rays SB1 is emitted from a projection surface 21 and is reflected by a first mirror 31 onto a curved mirror 32, which reflects it towards the mirror unit 4. The mirror unit 4 is shown herein as a windshield 41 of the motor vehicle. From there, the beam of rays SB2 travels towards an eye 61 of an observer.

The observer sees a virtual image VB, which is located outside the motor vehicle above the engine hood or even in front of the motor vehicle. Due to the cooperation of the optical unit 3 and the mirror unit 4, the virtual image VB is an enlarged representation of the image coming from the projection surface 21. A speed limit, the current vehicle speed and navigation instructions are symbolically shown here. As long as the eye 61 is located within the eyebox 62 indicated by a rectangle, all elements of the virtual image are visible to the eye 61. If the eye 61 is located outside the eyebox 62, the virtual image VB is only partially or not at all visible to the observer. The larger the eyebox 62, the less restricted the observer is in choosing their seating position. The curvature of the curved mirror 32 is adapted to the curvature of the windshield 41 and ensures that the image distortion is as stable as possible across the entire eyebox 62. The curved mirror 32 is rotatably mounted by means of a bearing 321. The rotation of the curved mirror 32 thus made possible enables displacement of the eyebox 62 and thus adjustment of the position of the eyebox 62 to the position of the eye 61. The first mirror 31 serves to ensure that the path covered by the beam of rays SB1 between the projection surface 21 and the curved mirror 32 is long, and at the same time, the optical unit 3 is nevertheless compact. The optical unit 3 is separated from the environment by a transparent cover 33. The optical elements of the optical unit 3 are thus protected, for example, against dust present in the interior of the motor vehicle. An anti-glare shield 34 is operable to safely absorb light reflected across the interface of the cover 33 so that the observer is not blinded. In addition to the sunlight SL, the light from another interference light source 64 may also reach the projection surface 21. The optical unit 3 has at least one wall 35 which is provided with a surface structure 351. Herein, the position, extent and shape of the wall 35 are shown schematically merely by way of example. Interference light SL′, which does not enter the optical unit 3 in the angular range of the beam of rays SB1 but can nevertheless cause interfering reflections visible to the observer, is influenced by the surface structure 351 such that these interfering reflections are as unnoticeable as possible, ideally even avoided entirely. The interference light SL′ may originate from the sun or another interference light source 64 if it is in a position other than that shown in the figure.

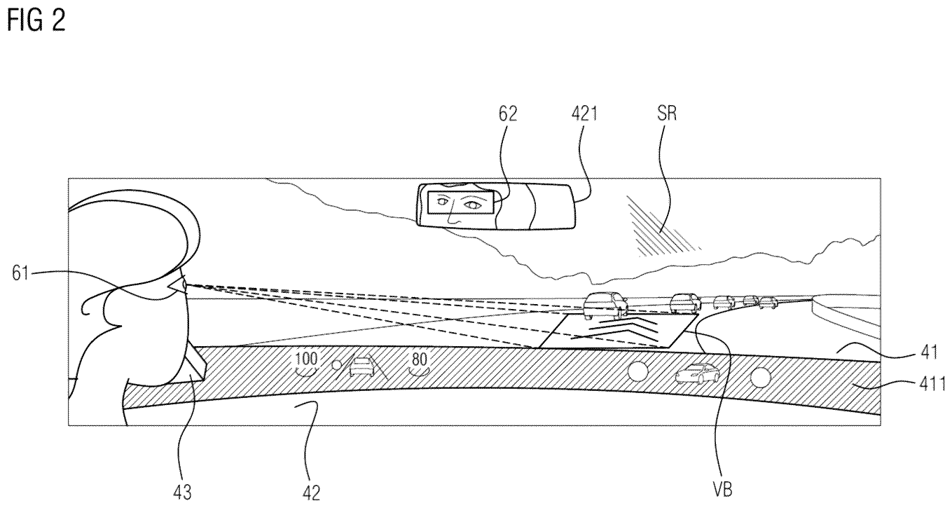

FIG. 2 shows a view from the interior of a motor vehicle through its windshield 41. In the lower area of the windshield, a shaded area 411, a cover 42 between the windshield 41 and the observer, and, on the far left, the lower part of the left A-pillar 43 can be seen. A rearview mirror 421 is arranged in the upper area of the windshield. In the mirror reflection thereof, the observer and the eyebox 62 can be seen. Through the windshield, the observer has a view of the road in front of the vehicle and the surrounding environment. The virtual image VB appears to be on the road. Above the virtual image VB, an interfering reflection SR is indicated schematically. It has a striped structure caused by a grooved surface structure 351 of a wall 35 of the optical unit 3. Even if the interference reflection SR indicated herein is located above the road, it may cause a distraction of the observer. It is even more disturbing if an interference reflection is located within the virtual image VB or nearby.

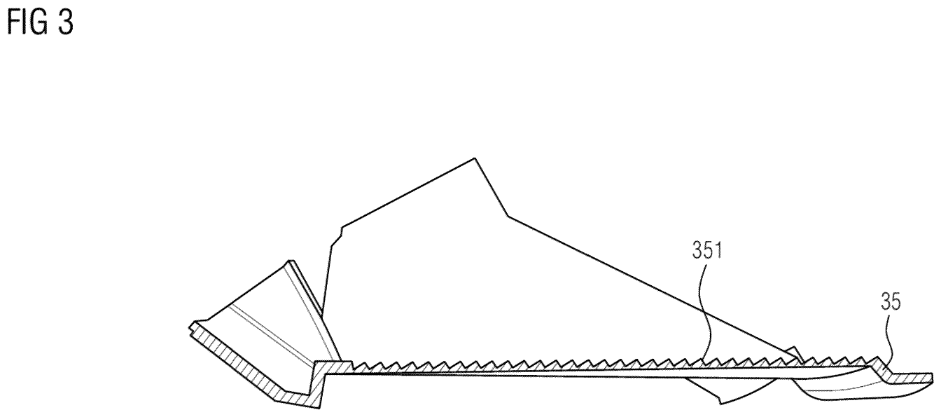

FIG. 3 shows a sectional view of an approach of methods A) +B): here, the wall 35 is an inner aperture of the HUD. The wall 35 is configured as a linearly grooved component with a black paint finish. The surface structure 351 thus consists of linear grooves arranged substantially parallel to one another. This improves the diffuse backscatter from the inner aperture into the observer's field of view. The only interference reflections SR remaining is a slight linear grooving visible as light-dark stripes and is hardly noticeable in the edge region of the virtual image VB visible to the observer. A surface of the wall 35, the inner aperture, is desired which achieves a suppression of diffuse backscatter comparable to the grooving, but does not cause any interference reflections perceived as disturbing in the region of the virtual image VB in the event of solar irradiation or other intensive interference light SL′.

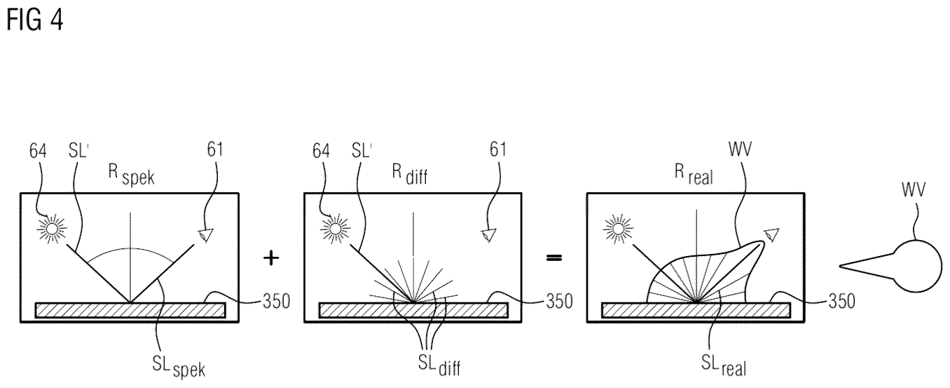

FIG. 4 schematically shows how the real reflection Rᵣₑₐₗ is composed of specular reflection Rₛₚₑₖ and diffuse reflection R_{diff}. With specular reflection Rₛₚₑₖ, interference light SL′ from an interference light source 64 reaches a surface 350 and is reflected there according to “angle of incidence equals angle of reflection”. The specularly reflected light reaches the eye 61 of an observer almost completely as specular interference light SLₛₚₑₖ. With diffuse reflection R_{diff}, interference light SL′ from an interference light source 64 reaches a surface 350 and is diffusely scattered there. The diffusely reflected light is distributed in almost all solid angles. Only a small fraction thereof reaches the eye 61 of an observer as diffuse interference light SL_{diff}. The angular distribution WV of the real interference light SLᵣₑₐₗ is composed of the angular distributions of the specular interference light SLₛₚₑₖ and the diffuse interference light SL_{diff}, as shown in the right panel of the figure. The angular distribution WV depends on the specular and diffuse reflective properties of the surface 350.

FIG. 5 shows an enlarged section of the wall 35 with grooving as the surface structure 351 from FIG. 3. What can be seen is the interference light SL′ incident from the top right in a relatively steep manner, which is reflected at the surface 350. The angular distribution WV of the real reflection is also shown. As can be seen, the maximum of the angular distribution WV is incident on an adjacent surface relatively perpendicularly, from which it is partially absorbed and partially reflected in a non-critical direction. Part of the angular distribution is incident on a curvature of the surface 350, where it is reflected in many different directions. Some of these contribute to the unwanted interference reflections SR.

The cause of the light-dark stripes of the interference reflection SR caused by the grooving is the fact that for a given solar irradiation (direction), each linear, raised structure (groove) produces a light reflection along the crests of the surface structure 351 (light stripe) and an increased light absorption along the valleys in between (dark stripe). This stripe arrangement (light-dark stripes) is clearly perceptible as interference light/interference reflex SR and is undesirable.

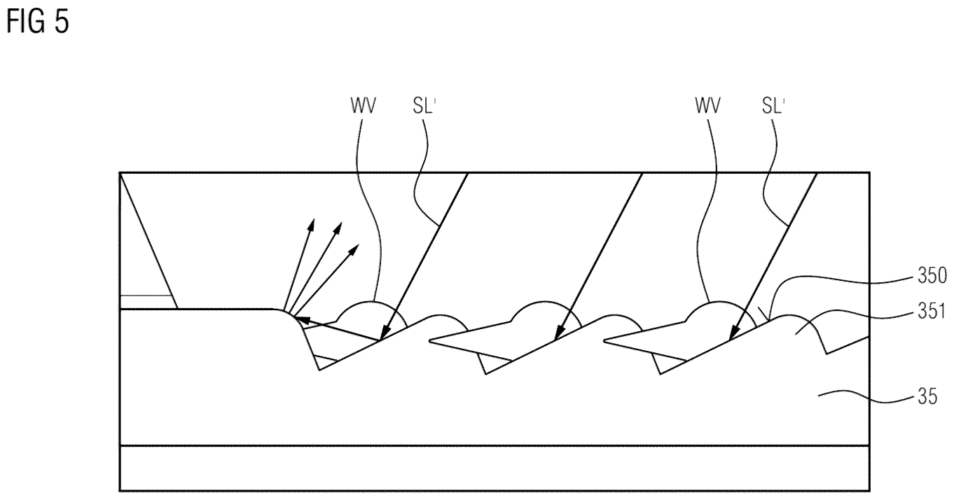

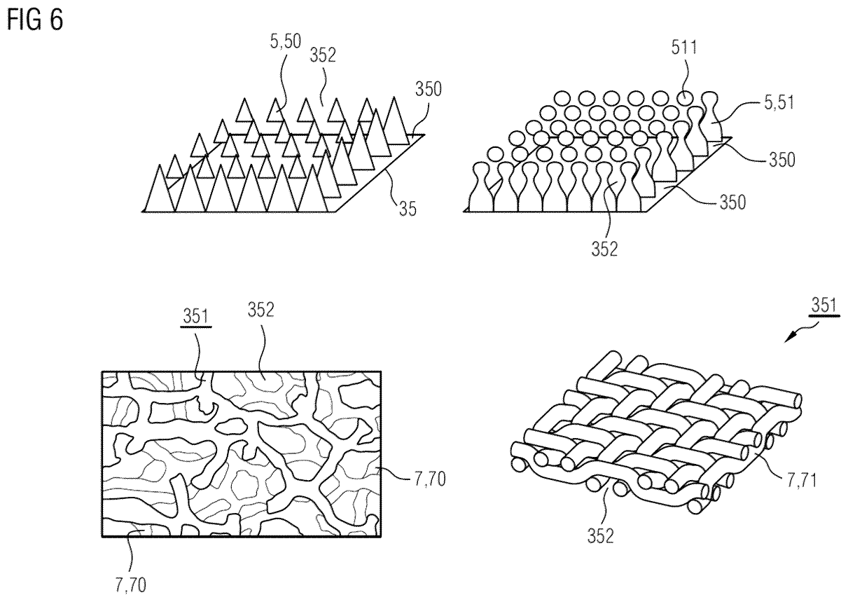

FIG. 6 shows multiple surface structures 351 according to an aspect of the invention. At the top left, a surface with a cone-peg surface structure can be seen. Many cones 50 of different sizes are arranged as an implementation of pegs 5 on a surface 350 of a wall 35. Herein, the cones 50 are shown two-dimensionally for the sake of simplicity. In fact, these are three-dimensional cones 50, however. The spaces between the cones 50 represent cavities 352 in which light is reflected multiple times and decreases in intensity due to absorption with each reflection. As can be seen, the cones 50 do not have any flat surfaces parallel to the wall 35. As can also be seen, the cavities 352 have a changing cross-section when approaching the wall 35 vertically. The top right shows a surface with a Halma-peg surface structure. Many Halma pegs 51 are arranged as an implementation of pegs 5 on a surface 350 of a wall 35. Here, too, a two-dimensional representation is provided for the sake of simplicity. Additionally, the Halma pegs 51 are shown completely only at the edge of the surface 350 shown, while in the middle of the surface shown, only the heads 511 of the Halma pegs 51 are indicated. Here, too, the spaces between the Halma pegs 51 represent cavities 352 in which the light is attenuated. Mesh grids can be seen in the lower panel of the figure. At the bottom left, an irregular surface structure 351 with spatially arranged bars 70 can be seen as an implementation of webs 7. Here, too, cavities 352 can be seen between the bars 70 of the surface structure 351. These cavities 352 have an irregular size and shape due to the irregular surface structure 351. The surface structure 351 does not have any flat surfaces, so that here, too, there are no flat surfaces parallel to a wall 35 not shown herein. At the bottom right, a regular surface structure 351 made of spatially interwoven tubular elements 71 can be seen as a further implementation of webs 7. Here, too, cavities 352 can be seen between the tubular elements 71 of the surface structure 351.

These alternative solutions according to an aspect of the invention and their effect are planar structures which effectively suppress the real=specular+diffuse scattered light. They have
A) Cavities 352 into which the interference light can enter,
b) pegs 5 or webs 7 between these cavities 352.

At the same time
a) the cavities 352 are of variable cross-section, and/or
b) the cavities 352 do not have any even boundary surfaces at their flanks, and/or
c) the pegs 5 or webs 7 on the upper side do not have any flat surfaces parallel to the base area of the wall 35, and/or
d) the pegs 5 or webs 7, as well as the base area of the wall 35, have a broadband light-absorbing surface 350, and/or
e) the mean structure height of the cavities 352 in relation to the mean opening width is a ratio of 1:2 or greater.

As has been shown: a flat arrangement of pegs 5 with round heads 511, also known as a Halma-peg plate with Halma pegs 51 arranged on a surface 350 which is painted black with inexpensive acrylic paint, achieves light absorption comparable to a component painted with an intensive and expensive black dye. If the Halma pegs 51 are replaced by pointed cones 50, the brightness of the scattered light decreases further significantly.

An aspect of invention proposes cavities 352 of variable cross-section. A substantial feature is the existence of one or more constrictions at which the cross-section of the cavity 352 has a minimum in its vertical course. For example, in the Halma-peg arrangement, there is a constriction between the heads 511 and a second one at the very bottom end of the Halma pegs 51. Further, the cavities narrow sharply towards the wall where adjacent Halma pegs touch. Where adjacent Halma pegs do not touch directly, the wall delimits the cavity with a remaining even surface. However, the latter may also be advantageously configured in a curved manner to suppress vertically incident and re-exiting interference light.

The mesh grid does not necessarily have to be square; rectangular or more complicated woven fabrics are also possible. The regular and irregular mesh grids from the lower panel of FIG. 6 also have the cavities 352 with constrictions. Due to the tubular shape, specular reflection at the upper side (i.e., the side facing the scattered light) is less likely than with spherical upper sides.

A characteristic of all mesh grids is that the variable cavities 352 are formed by a woven fabric made of long fibers, such as the beams 70 or the tubular elements 71. In this respect, it should be noted that spatial grid structures such as nickel foams (as employed in battery electrodes) also comply with the features (cavities 352, variable cross-section, constrictions, etc.), and that they also work well when configured in black.

FIG. 7 shows a side view and cross-section (top view) of different examples of pegs 5. The upper row R1 of the side view shows from left to right: a large Halma peg 51, a small Halma peg 51, a large pointed cone 50, a small pointed cone 50, a Halma peg 51 with a pointed cap 512, stacked pointed cones 520, 521 forming a Christmas tree 52 with several levels, and an arrowhead 53, similar to a Christmas tree with a trunk. Underneath, the respective variants with a “round” cross-section can be found in the second row R2 from the top, with an “elliptical” cross-section in the third row R3 from the top and with a “free-form cross-section” in the bottom row R4.

A certain disadvantage of the Halma pegs 51 are the spherical upper sides at the head 511. Here, the light from a scattered light source always finds a direct specular reflection to the observer, even if only over a small area or spot, for example. This is avoided with the Halma peg 51 with an attached ‘pointed cap’ 512. Here, the ‘Christmas tree’ 52 and the arrowhead 53, i.e., the pointed cone on the trunk (or on a second/third etc. pointed cone 520, 521, 52n) are also a solution according to the requirement ‘cavity 352 with one or more constrictions.’

It can be seen that the structure width STB of all the structures shown, here peg 5, is less than their structure height STH. This is also the height of the cavities created between the structures. In turn, the opening width of these cavities is in the range of the structure width STB when the structures are arranged closely, as shown in FIG. 6. The ratio of structure height STH to structure width STB (equal to the opening width of the cavities when arranged closely) has a value STH/STB>1.5. In the examples shown herein, this ratio has a value of about two.

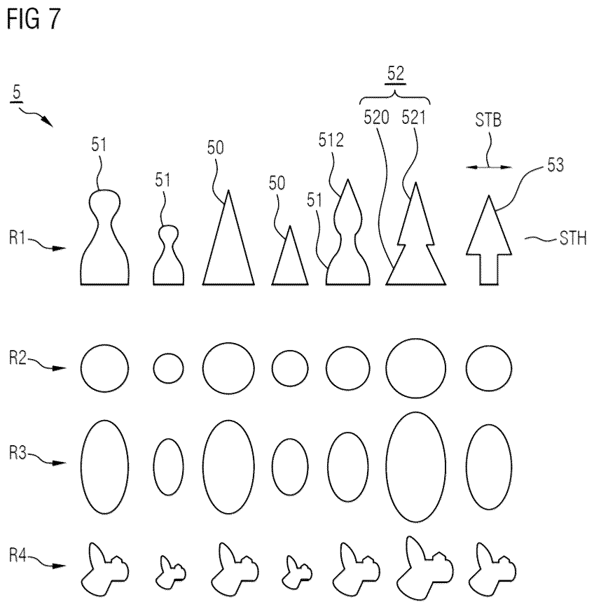

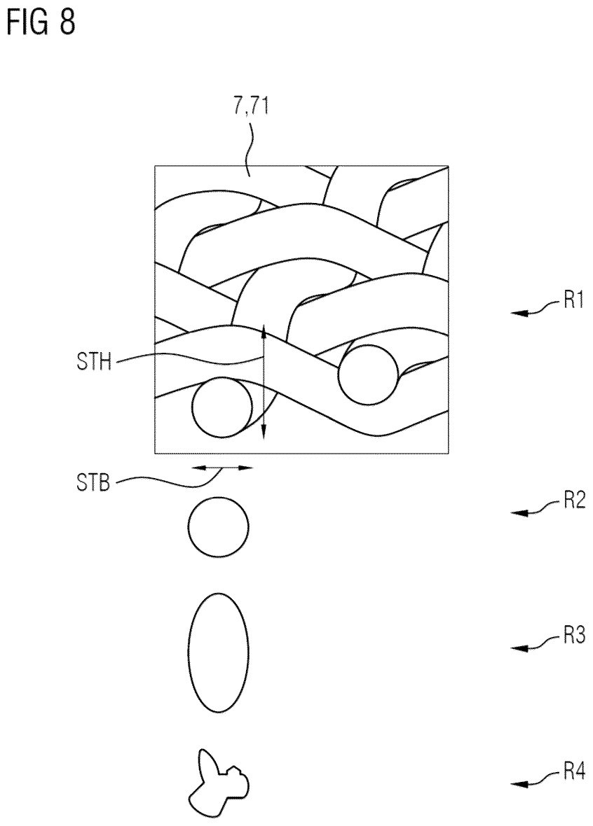

FIG. 8 shows an oblique top view of an example grid with tubular elements 71 in row R1. Underneath, different cross-sections of the tubular elements 71 are shown as examples: round in row R2, elliptical in row R3 and as a free curve in row R4. Here, too, it can be seen that the ratio of structure height STH to structure width STB has a value STH/STB>1.5.

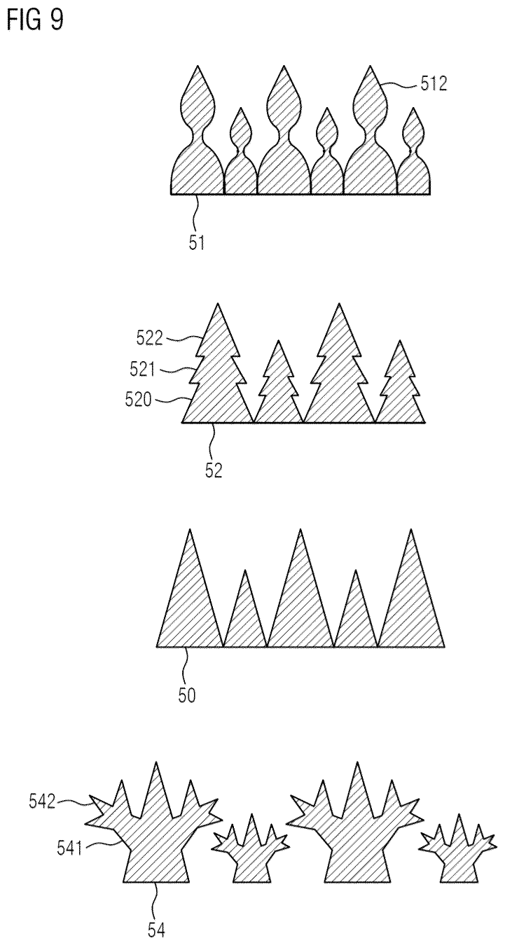

FIG. 9 shows a cut-out cross-sectional diagram of further advantageous surface structures with different examples of pegs 5. The top left shows Halma pegs 51 with attached pointed caps 512 of different sizes arranged adjacent to one another. In the top center, Christmas trees 52 with three levels of pointed cones 520, 521, 522 and of different sizes are arranged adjacent to one another. At the top right, pointed cones 50 of different sizes are arranged adjacent to one another.

FIG. 10 shows three Halma pegs 51 with pointed caps 512 by way of example. They have the same structural width STB and structural height STH. The cavities 352 formed in between have an opening width OW which approximately corresponds to the structure width STB. The ratio of structure height STH to opening width OW in this figure is about 2:1.

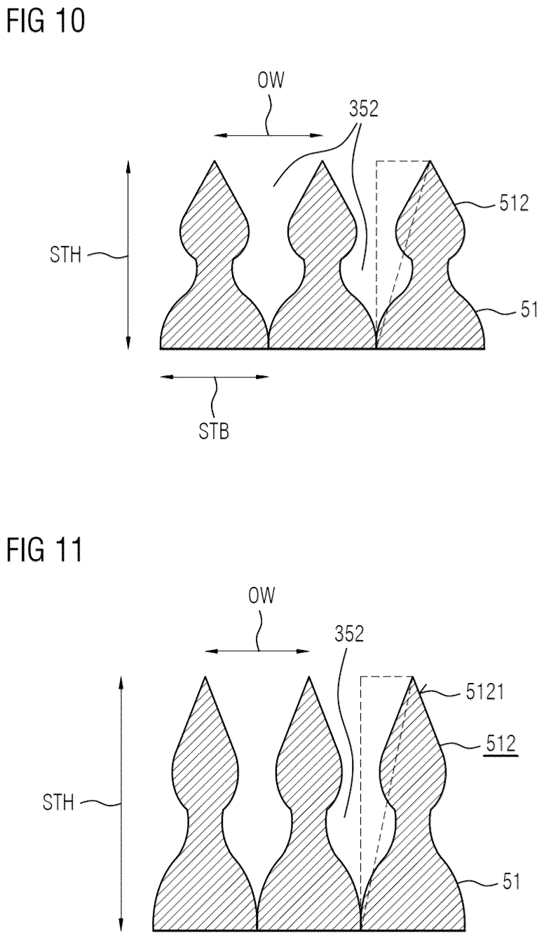

FIG. 11 shows three Halma pegs 51 with pointed caps 512 by way of example, as in the figure above. They have the same structural width STB and structural height STH. The cavities 352 formed in between have an opening width OW which approximately corresponds to the structure width STB. The ratio of structural height STH to opening width OW in this figure is about 3:1. It can be seen that the flanks 5121 of the pointed caps 512 are quite steep. Light incident from outside the cavities 352 is thus largely reflected into the cavity. Only a very small portion of the light entering from outside through the opening width thus leaves the cavities 352 directly or after only a few reflections.

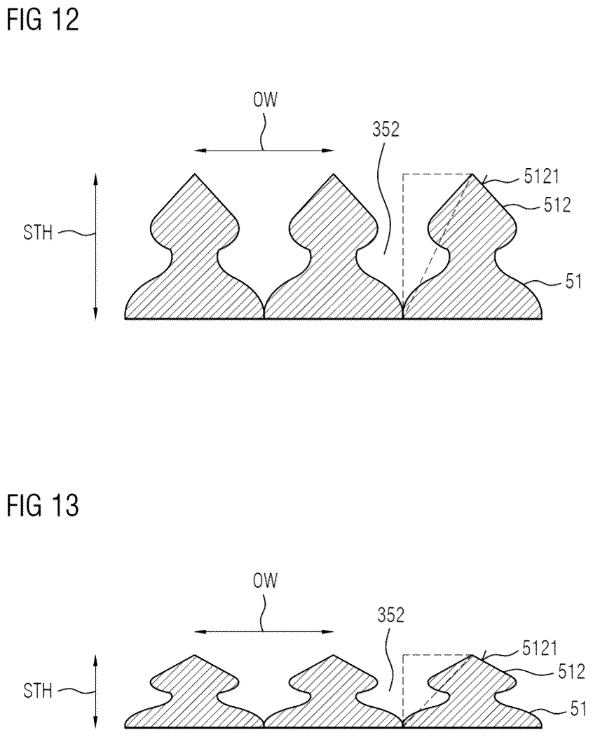

FIG. 12 shows three Halma pegs 51 with pointed caps 512 by way of example, as in the figure above. The ratio of structural height STH to opening width OW in this figure is about 1:1. It can be seen that the flanks 5121 of the pointed caps 512 are less steep than in the previous figure. Nevertheless, even here only a small portion of the light entering from outside through the opening width leaves the respective cavity directly or after only a few reflections.

FIG. 13 shows three Halma pegs 51 with pointed caps 512 by way of example, as in the figure above. The ratio of structural height STH to opening width OW in this figure is about 1:2. It can be seen that the flanks 5121 of the pointed caps 512 are even less steep than in the previous figure. Nevertheless, even here, only a relatively small portion of the light entering from outside through the opening width leaves the respective cavity directly or after only a few reflections.

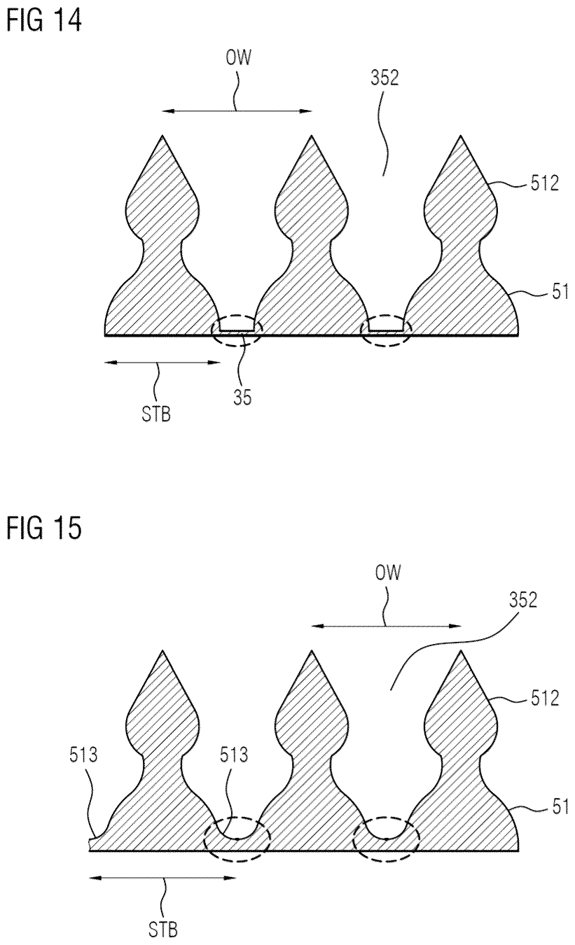

FIG. 14 shows three Halma pegs 51 with pointed caps 512 by way of example, as in the figure above. Here, the Halma pegs are spaced apart in their base region. Thus, the opening width OW has a larger value than the structural width STB. In the dashed region, it can be seen that there are even regions on the upper side of the wall 35. Light falling directly onto these regions is largely reflected at wall regions of the cavities 352 and is therefore largely absorbed within the cavities.

FIG. 15 shows three Halma pegs 51 with pointed caps 512 by way of example, as in the figure above. Here, too, the Halma pegs are spaced apart in their base region. However, the Halma pegs 51 have a rounded base 513. Thus, the opening width OW again has about the same value as the structural width STB. In the dashed region, it can be seen that there are no even regions on the upper side of the wall 35. Thus, even less of the light entering from outside through the opening width OW may leave the cavity directly or after only a few reflections.

According to an aspect of the invention, it is proposed to not necessarily use ‘pegs’ 5 of only one uniform size in a regular arrangement but to place multiple sizes in a mixed arrangement. This ensures variable cavities 352 and constrictions.

The lower part of FIG. 9 shows the possibility of branched structures 54, i.e., multi-level ‘pegs’ 5 with ramifications 541, 542. Ultimately, it is a ‘forest’ of ‘pegs’ 5 with ‘cavities’ 352 in between, which, like a real forest of trees, ‘swallow’ as much light as possible.

The proposed arrangements of cavities 352 are volume structures which necessarily have a certain thickness, which, however, becomes smaller the smaller the dimensions therein (pegs 5, webs 7, etc.) can become. This is initially a disadvantage compared to ‘thin’ coatings, such as graining or varnishing. However, when scaling down to smaller dimensions and increasing the number of structures per unit area, practical material thicknesses are achieved.

Until the current advent of additive manufacturing processes, the arrangements of cavities 352 according to an aspect of the invention were very complex to produce because they are not demoldable from linearly moved tools (lost molds are very costly). The inventor has recognized that this can probably be achieved more easily in the future using additive manufacturing processes.

The solution according to an aspect of the invention takes into account that the reflection of scattered light is simultaneously diffuse and specular. According to an aspect of the invention, both direct specular reflection and a multi-level, random sequence of specular and diffuse reflection to the observer are prevented. Cavities 352 according to an aspect of the invention with constrictions can do this better than any surfaces to be demolded linearly.

The 352 cavities with constrictions act similarly to a fish trap:
light finds its way in more easily than out; they are very effective ‘light swallowers,’ even if the raw material surface is not particularly matte microscopically; simple coatings or pigmentations are sufficient.

It turned out that better black levels are actually achieved. Even the Halma pegs 51 with a slightly matt paint finish (acrylic paint from the hardware store) can compete with high-performance matt paints or graining of all kinds. The pointed cones 50, Christmas trees 52, arrowheads 53 are even “blacker,” as measurements have shown.

Another advantage of the solution according to an aspect of the invention is its appearance. The proposed structures are—seen macroscopically (from a distance)—‘homogeneous’, unlike the prism-shaped ribs, which act as coarse light traps and create a striped image in the field of view.

Planar structures such as prismatic ribs, pyramids, etc. are geometrically simple to construct and manufacture, but disadvantageous due to direct specular reflection. Such structures are mainly suitable in arrangements with a fixed geometry of the interference light source relative to the observer. However, this is not the case with the sun being the main source of interference light in head-up display housings. Sometimes it comes from here and sometimes from there; both the car moves while driving and the sun moves during the day, both viewed from a fixed reference system, Earth.

The sun is also exceptionally bright as a source of interference light. In good weather/daytime conditions, it delivers 1.6 giga cd/m², which in turn makes it extremely difficult to make surfaces appear very dark under solar irradiation. The sun provides so much light that even a multi-level specular and/or diffuse reflection can still be very bright as interference light in relation to the effective light. The inventor has recognized that a good result can nevertheless be achieved with specular and/or diffuse reflection if cavities 352 according to an aspect of the invention are provided.

1. A device having an optical unit which has at least one inner wall provided with a surface structure wherein the surface structure has cavities

2. The device according to claim 1, wherein the cavities are formed by pegs and/or webs.

3. The device according to claim 2, wherein the pegs and/or webs are arranged on the wall, on the one hand, and do not have any flat surfaces parallel to the wall on their upper side facing away from the wall, on the other hand.

4. The device according to claim 2, wherein the cavities formed by pegs and/or webs have a mean opening width parallel to the surface of the wall and a height perpendicular to the surface of the wall wherein the ratio of height-to opening width has a value of 0.5 or greater.

5. The device according to claim 1, wherein the cavities have an irregularly shaped cross-section.

6. The device according to claim 1, wherein the flanks of the cavities and/or the pegs and/or the webs have uneven boundary surfaces.

7. The device according to claim 1, wherein the flanks of the cavities and/or the pegs and/or the webs have a broadband light-absorbing surface.

8. The device according to claim 1, wherein the cavities do not have any flat surfaces at their deepest point towards the wall

9. The device according to claim 2, wherein the pegs are pointed cones with a round base.

10. The device according to claim 2, wherein the pegs have the shape of a Halma peg with a pointed cap.

11. The device according to claim 2, wherein the pegs and/or the webs consist of a hard material.

12. The device according to claim 2, wherein the pegs and/or the webs consist of a material which is able to be applied in an additive process, wherein the additively produced, smallest possible volume elements do not combine to form a smooth surface, but instead produce a roughness of the surface.

13. A head-up display, comprising a device according to claim 1.
